(19) United States
(12) Patent Application Publication
(10) Pub. No.: US 2026/0119591 A1
(43) Pub. Date: Apr. 30, 2026

(54) APPARATUS FOR MATCHING URLS AT HIGH SPEED AND METHOD THEREOF

(71) Applicant: SYSMATE CO., LTD., Daejeon (KR)

(72) Inventors: Yong Hun KIM, Daejeon (KR); Won Yong JUNG, Daejeon (KR); Shin Il MOON, Daejeon (KR); Gan Ho CHOI, Daejeon (KR)

(73) Assignee: SYSMATE CO., LTD., Daejeon (KR)

(21) Appl. No.: 19/333,977

(22) Filed: Sep. 19, 2025

(30) Foreign Application Priority Data
Oct. 30, 2024 (KR) 10-2024-0150651

(51) Int. Cl. G06F 16/955; G06F 16/957

(52) U.S. Cl. CPC G06F 16/9566; G06F 16/9574

(57) ABSTRACT

Provided are an apparatus for matching URLs at high speed and a method thereof. According to the present invention, an input URL is parsed to separate host information and path information, and a host map and a URL hash map are registered. When a search target URL is input, URL matching is attempted in the registered host map and URL hash map, giving priority to the longest path based on path length, and a policy (action) is applied according to the matching result, thereby increasing matching speed.

### CROSS-REFERENCE TO RELATED APPLICATION(S)

This application claims the benefit under 35 U.S.C. § 119 (a) of Korean Patent Application No. 10-2024-0150651, filed on Oct. 30, 2024, in the Korean Intellectual Property Office, the entire disclosure of which is incorporated herein by reference for all purposes.

### BACKGROUND

### 1. Field

The following description relates to URL search technology, and more particularly, to a technology for searching for URLs at high speed using a URL map.

### 2. Description of Related Art

A Uniform Resource Locator (URL) is an address that specifies the location of a resource (such as a web page, image, or file) on the web. A URL consists of various components that are used to identify and access a particular resource.

The components of a URL include a scheme, a host, and a path.

The scheme is the leading portion of the URL and defines the protocol to be used. Examples may include http, https, ftp, and the like.

The host is the domain name or IP address of the server where the resource is located. For example, there is www.example.com.

The path specifies the location of a specific resource within the server. For example, there is/path/to/resource.

A user may request resources by inputting a URL when accessing a web page, may use URLs when calling API endpoints in communication between a server and a client, and may create links to other pages or files using URLs.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

According to an embodiment, a URL matching apparatus for searching URLs at high speed using a URL map and a high-speed URL matching method using the same are proposed.

In one general aspect, there is provided a method of matching URLs, including: parsing an input URL to separate host information and path information and calculating path depth; registering a host map for the host information of the input URL; when the input URL includes the path information, registering a URL hash map for the corresponding path; when a search target URL is input, matching a host in the registered host map and, when a match is found, attempting path matching in the URL hash map for the corresponding path by giving priority to the longest path based on path length; and applying a policy (e.g., action) according to the matching result.

The registering of a host map may include determining a registration method of the host map according to whether the input URL includes only host information or includes both host information and path information, and whether the host of the input URL is the same as an existing host.

The registering of a host map may include managing path URL count information of the host to prevent duplicate URL registration.

The registering of a URL hash map may include searching for a URL hash map corresponding to a URL path step (or depth) and registering the URL in the found URL hash map.

The registering of a URL hash map may include pre-allocating a size of a URL hash map buffer according to a length of the input URL to prevent memory waste.

The matching by giving priority to the longest path may include: checking a path URL count value of the host map when the host is matched in the host map; transferring a policy of the host map when the path URL count value of the host map is 0; and searching the URL hash map to check whether path matching is successful when the path URL count value of the host map is greater than 0.

The matching by giving priority to the longest path may include, when the attempt to match the longest path fails during the URL matching process, attempting path matching while descending step by step to shorter paths.

The matching by giving priority to the longest path may include: attempting path matching at a URL path step of the longest path using a hash value of the URL having the longest path, and when matching is successful, transferring a policy of a URL hash map corresponding to the longest path; when matching of the longest path fails, repeatedly attempting path matching by descending to previous URL path steps until matching is successful; when matching is successful at a certain URL path step, transferring a policy of a URL hash map corresponding to the matched URL path step; and transferring a policy of the host map when path matching ultimately fails in the URL hash map.

In another general aspect, there is provided an apparatus for matching URLs, including: a URL parsing unit configured to parse an input URL to separate host information and path information and calculate path depth; a host map registration unit configured to register a host map for the host information of the input URL; a URL hash map registration unit configured to, when the input URL includes the path information, register a URL hash map for a corresponding path; a URL matching unit configured to, when a search target URL is input, match a host in the registered host map, and, when matched, attempt path matching in the URL hash map of the corresponding path by giving priority to the longest path based on path length; and a policy implementation unit configured to apply a policy according to the matching result.

The URL matching unit may check a path URL count value of the host map when the host is matched in the host map, transfer a policy of the host map when the path URL count value of the host map is 0, and search the URL hash map to check whether path matching is successful when the path URL count value of the host map is greater than 0.

The URL matching unit may, when the attempt to match the longest path fails during the URL matching process, attempt path matching while descending step by step to shorter paths.

The URL matching unit may attempt path matching at a URL path step of the longest path using a hash value of the URL having the longest path, when matching is successful, transfer a policy of the URL hash map corresponding to the longest path, when matching of the longest path fails, repeatedly attempt path matching by descending to previous URL path steps until matching is successful, when matching is successful at a certain URL path step, transfer a policy of a URL hash map corresponding to the matched URL path step, and transfer the policy of the host map when the path matching ultimately fails in the URL hash map.

Other features and aspects will be apparent from the following detailed description, the drawings, and the claims.

### BRIEF DESCRIPTION OF THE DRAWINGS

FIG. 1 is a diagram illustrating a configuration of an apparatus for matching URLs according to an embodiment of the present invention.

FIG. 2 is a diagram illustrating a detailed configuration of a control unit of FIG. 1 according to an embodiment of the present invention.

FIGS. 3 and 4 are diagrams illustrating examples of registering a host map according to an embodiment of the present invention.

FIG. 5 is a diagram illustrating an example of URL hash map registration according to an embodiment of the present invention.

FIG. 6 is a diagram illustrating a flow of a method of matching URLs according to an embodiment of the present invention.

FIG. 7 is a diagram illustrating a URL search process according to a URL path step of a search target URL according to an embodiment of the present invention.

FIG. 8 is a diagram illustrating an example of a URL search process for a search target URL according to an embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The advantages and features of the present invention and the manner of achieving the advantages and features will become apparent with reference to embodiments described in detail below together with the accompanying drawings. However, the present invention may be implemented in many different forms and should not be constructed as being limited to the embodiments set forth herein, and the embodiments are provided such that this disclosure will be thorough and complete and will fully convey the scope of the present invention to those skilled in the art, and the present invention is defined only by the scope of the appended claims. The same reference numerals refer to the same components throughout the description.

In the following description of the embodiments of the present invention, if a detailed description of related known functions or configurations is determined to unnecessarily obscure the gist of the present invention, the detailed description thereof will be omitted herein. The terms described below are defined in consideration of the functions in the embodiments of the present, and these terms may be varied according to the intent or custom of a user or an operator. Therefore, the definitions of the terms used herein should follow contexts disclosed herein.

Hereafter, embodiments of the present invention will be described in detail with reference to the accompanying drawings. However, the present invention may be realized in various forms, and the scope of the present invention is not limited to such embodiments. The embodiments of the present invention are provided to aid those skilled in the art in the explanation and the understanding of the present invention.

Prior to a description of embodiments of the present invention, the terms used herein will be defined as follows.

A Uniform Resource Locator (URL) consists of a host (HOST) and a path (PATH). The host is the domain name, and the path indicates the path to a resource. For example, if the URL is www.naver.com/video/stream/player, the host is www.naver.com and the path is/video/stream/player. A URL may consist only of a host or of both a host and a path.

A URL path step or depth is a unit value of the URL path. The delimiter “/” may be used to separate path steps of the URL path. For example, www.naver.com/video corresponds to path step 1 or level 1 (depth 1), and www.naver.com/video/stream corresponds to path step 2 or level 2 (depth 2).

A hash is a value generated by combining the host and path of a URL. A unique hash value may be generated using a hash algorithm such as CRC32.

A policy (action) refers to the manner in which a search target URL is processed when a match occurs. For example, the policy may include data processing methods such as blocking, bypassing, controlling, redirection, and notification.

A buffer pool is a collection of unused buffers (memory spaces in which URLs are stored).

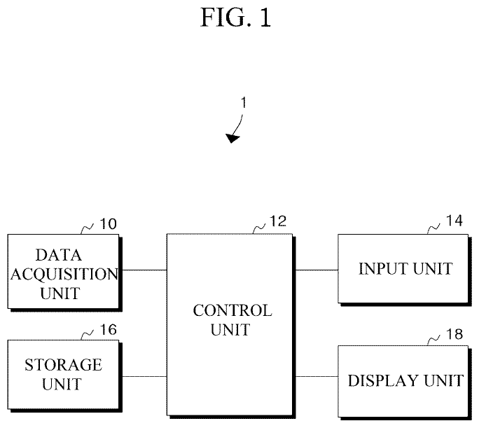

FIG. 1 is a diagram illustrating a configuration of an apparatus for matching URLs according to an embodiment of the present invention.

Referring to FIG. 1, an apparatus 1 for matching URLs may be a computing device.

The apparatus 1 for matching URLs may be implemented as an electronic terminal or as a server-client system, and when implemented as a server-client system, the apparatus 1 may include an electronic terminal on which an online service application for interaction with users is installed. The electronic terminal may be implemented as a computer, a portable terminal, a television, a wearable device, or the like, which is capable of accessing a remote server via a network or of connecting to other terminals and servers.

The apparatus 1 for matching URLs relates to a technique for searching for a URL that matches a search target URL provided as a string, wherein URL matching is attempted by giving priority to the longest path based on the path length of the URL, so as to search for a matching URL. By prioritizing a URL having the longest path, processing load for long string searches may be reduced, and matching speed may be increased.

“Matching” refers to comparing an input search target URL with a stored table to check if there is a match. If a match is found, the matching is considered successful, and if not, the matching is considered unsuccessful.

The apparatus 1 for matching URLs according to an embodiment includes a data acquisition unit 10, a control unit 12, an input unit 14, a storage unit 16, and a display unit 18.

The data acquisition unit 10 acquires URL data. The URL data is composed of a character string. The URL data may be used for URL registration or search.

The control unit 12 may control the overall operation of the apparatus 1 for matching URLs and may include a processor such as a central processing unit (CPU), a graphics processing unit (GPU), or the like. The control unit 12 may control other components included in the apparatus 1 to perform an operation corresponding to a user input received through the input unit 14. The control unit 12 may apply a program stored in the storage unit 16, read a file stored in the storage unit 16, or store a new file in the storage unit 16.

The control unit 12 performs functions such as URL registration, URL search, and policy implementation.

The URL registration function parses the input URL data to separate host information and path information, calculates path depth, and then registers a host map and a URL hash map.

The host map includes the host and policy information of the input URL. If the input URL includes path information, a URL hash map for a corresponding path may be registered.

The URL search function, when a search target URL is input, searches the registered host map and URL hash map for a URL that matches the search target URL. For example, a host may be searched in the registered host map, and if a match is found, matching through the URL hash map of the corresponding path may be attempted to search for a matching URL. At this time, during path matching, the control unit 12 may give priority to the longest path based on the path length of the URL.

The policy implementation function applies a predefined policy according to the matching result.

The input unit 14 receives a user operation signal. In this case, the input unit 14 may receive a user operation signal for a user interface (UI, hereinafter referred to as “UI”) displayed on the screen.

The storage unit 16 may have various types of data, such as files, applications, and programs, installed and stored therein. The control unit 12 may access and use data stored in the storage unit 16, or may store new data in the storage unit 16. In addition, the control unit 12 may apply a program installed in the storage unit 16. Referring to FIG. 1, a URL matching result provision program for performing a URL matching method may be installed in the storage unit 16.

The storage unit 16 stores various types of data required for operation of the apparatus 1 and data generated during the operation. For example, the registered host map and URL hash map may be stored in the storage unit 16.

The display unit 18 displays information on the screen. For example, the display unit 18 may display the result of task execution on the screen. The display unit 18 may include a display panel that displays the screen.

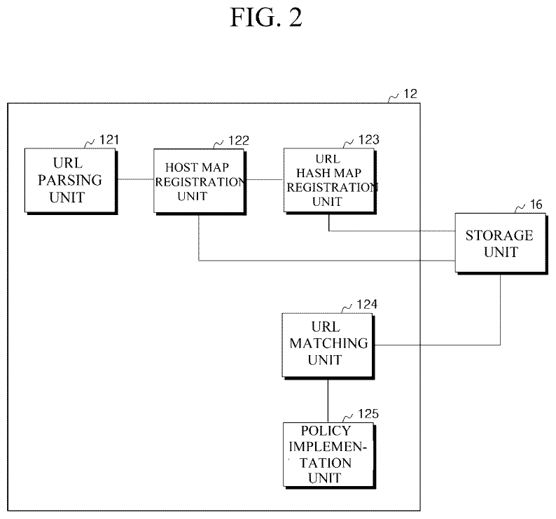

FIG. 2 is a diagram illustrating a detailed configuration of the control unit of FIG. 1 according to an embodiment of the present invention.

Referring to FIGS. 1 and 2, the control unit 12 includes a URL parsing unit 121, a host map registration unit 122, a URL hash map registration unit 123, a URL matching unit 124, and a policy implementation unit 125.

The URL parsing unit 121 parses an input URL to separate host information and path information and calculates path depth.

The host map registration unit 122 registers a host map for the host information of the input URL.

The host map registration unit 122 may determine a registration method of the host map according to whether the input URL includes only host information or includes both host information and path information, and whether the host of the input URL is the same as an existing host. The host map registration unit 122 may manage path URL count information of the host so as to prevent duplicate URL registration.

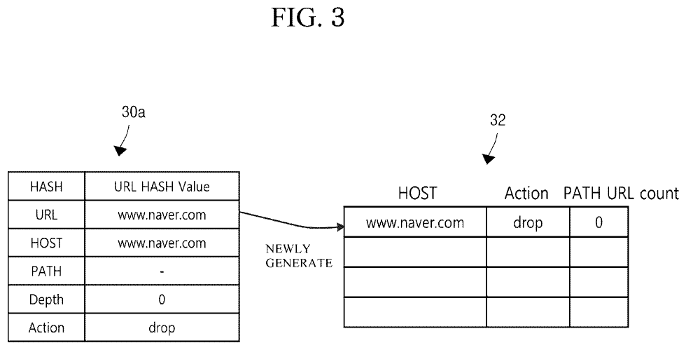

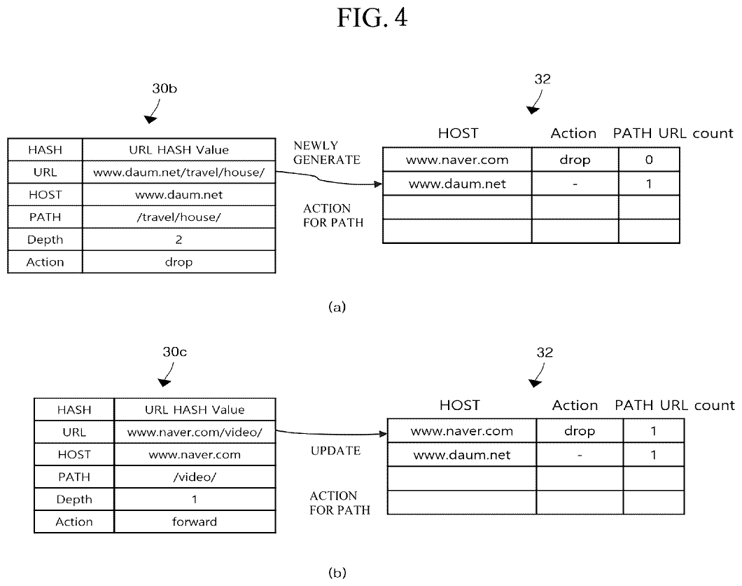

Examples of host map registration by the host map registration unit 122 will be described below with reference to FIGS. 3 and 4.

When the input URL includes path information, the URL hash map registration unit 123 registers a URL hash map for a corresponding path. The URL hash map registration unit 123 may search for a URL hash map corresponding to a URL path step and register the URL in the found URL hash map.

The URL hash map registration unit 123 may pre-allocate the size of a URL hash map buffer according to the length of the input URL, thereby preventing memory waste.

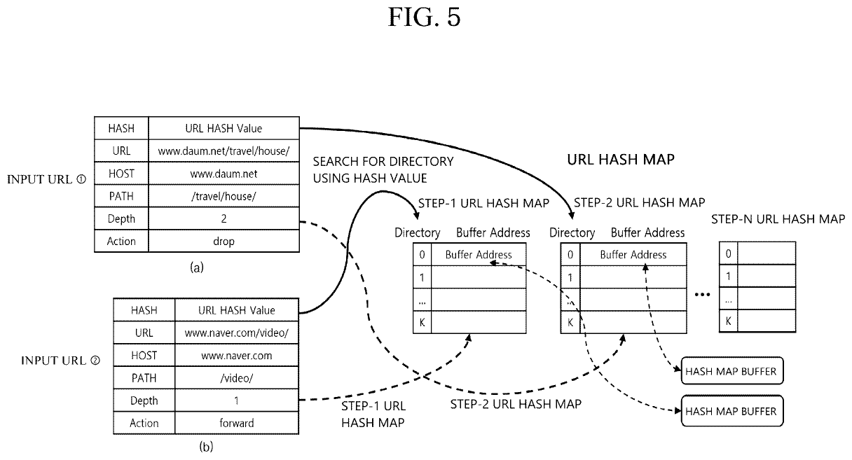

An example of URL hash map registration by the URL hash map registration unit 123 will be described below with reference to FIG. 5.

The URL matching unit 124 receives a search target URL and searches for a URL matching the search target URL in the registered host map and URL hash map. In this case, the URL matching unit 124 matches the host in the registered host map, and when matched, attempts path matching in the URL hash map of the corresponding path by giving priority to the longest path based on path length.

The URL matching unit 124 may check the path URL count value of the host map when the host is matched in the host map. If the path URL count value of the host map is 0, the policy of the host map may be transferred. In contrast, if the path URL count value of the host map is greater than 0, the URL hash map may be searched to check whether path matching is successful.

When the attempt to match the longest path fails during the URL matching process, the URL matching unit 124 may attempt matching while descending step by step to shorter paths. For example, the URL matching unit 124 may attempt path matching using the hash value of the URL having the longest path, and if the matching is successful, may transfer the policy of the URL hash map corresponding to the longest path. In this case, if matching of the longest path fails, the URL matching unit 124 may repeatedly attempt path matching by descending to previous URL path steps until matching is successful. When matching is successful at a certain URL path step, the URL matching unit 124 may transfer the policy of the URL hash map corresponding to the matched URL path step. However, if the path matching ultimately fails in the URL hash map, the policy of the host map may be transferred.

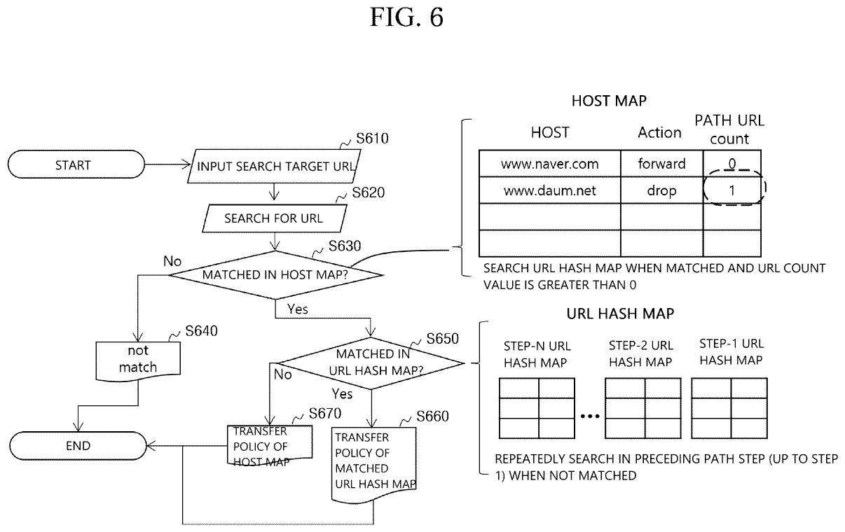

Examples of URL matching by the URL matching unit 124 will be described below with reference to FIGS. 6 to 8.

The policy implementation unit 125 applies a policy according to the matching result of the URL matching unit 124. The policy may include an action such as allowing, blocking, or redirecting the URL.

FIGS. 3 and 4 are diagrams illustrating examples of registering a host map according to an embodiment of the present invention.

More specifically, FIG. 3 illustrates an example of registering a host map of a URL that includes only host information, and FIG. 4 illustrates an example of registering a host map of a URL that includes both host information and path information.

The host map is a data structure that stores and manages rules, policies, and metadata associated with a URL, based on host information of the URL. This structure plays a crucial role in efficiently processing URL requests in web applications or security systems.

The host map may include host information, rule information, metadata, and policy information.

Host information is the domain portion of a URL. For example, www.example.com is the host. Rule information defines the rules or policies that apply to each host. This may include an action such as allowing, blocking, or redirecting a URL path. Metadata is additional information about the host and may include the number of URLs, the registration date, the last modification date, and the like. Policy information refers to actions performed according to each URL rule. Examples include BLOCK, ALLOW, REDIRECT, and the like.

The apparatus 1 for matching URLs may perform a host map registration function, a search function, a delete function, a policy implementation function, and the like.

The registration (add) function adds a new host and associated rules to the host map. If the host already exists, rules may be added or updated to the corresponding host.

The search function searches for a host in response to a search request for a search target URL and checks the corresponding rules. Additional rules may be searched based on the path of the URL.

The delete function removes a specific host and its associated rules from the map.

The policy implementation (apply action) function applies a policy to the host of a requested URL and performs an action such as blocking, allowing, or redirecting.

FIGS. 3 and 4 illustrate examples of the host map registration (add) function.

Referring to FIGS. 1, 3, and 4, a URL is composed of host information and path information. The apparatus 1 for matching URLs parses input URL data in string form to separate host information and path information, and then calculates the path depth.

Next, the apparatus 1 registers the host information from the parsed input URL data in the host map. The host map may include host, policy, and path URL count information.

When the input URL includes a path, the apparatus 1 for matching URLs increases the path URL count of the corresponding host by one (if the URL is generated without duplication). If a host having the same name as the input host already exists in the host map, the policy information, the path URL count information, and the like of the existing host map are updated. Hereinafter, with reference to FIG. 3, a process of registering in the host map when the input URL includes only host information will be described.

As shown in FIG. 3, the apparatus 1 for matching URLs confirms from data 30a parsed from the input URL that the input URL includes only host and policy information without a path, and then searches to determine whether the host of the input URL is the same as an existing host.

In this case, when the host is not duplicated (e.g., input host: www.daum.net, existing host: www.naver.com), the apparatus 1 creates new host information in a host map 32 and stores policy information. At this time, the path URL count information is not increased.

In contrast, when the host is duplicated (e.g., input host: www.naver.net, existing host: www.naver.com), only the policy information in the existing host map is updated.

Hereinafter, with reference to FIG. 4, a process of registering a host map when the input URL includes both host information and path information will be described.

As shown in FIG. 4, when the apparatus 1 for matching URLs confirms from data 30b parsed from the input URL that the input URL includes host information and path information, the apparatus 1 searches for whether the input host is the same as an existing host.

At this time, the apparatus 1 for matching URLs confirms from data 30c parsed from the input URL that the input URL includes host information and path information, and when the host of the input URL is not the same as an existing host (as shown in (a) of FIG. 4), the apparatus newly generates and registers host information in the host map 32. For example, when the input host is “www.daum.net,” since it is not the same as the existing host (www.naver.com), host information is newly generated and registered in the host map 32. In this case, the policy information is stored in the URL hash map in which the URL path is registered. Furthermore, when the path is not the same as that of a URL of an existing URL hash map, the apparatus 1 for matching URLs increases the path URL count by one.

The apparatus 1 for matching URLs confirms from the data 30c parsed from the input URL that the input URL includes host information and path information, and if the host of the input URL is the same as an existing host (as shown in (b) of FIG. 4), the apparatus 1 does not generate new host information in the host map since the same host already exists. In this case, if the path of the input URL is not the same as that of a URL of an existing URL hash map, the path URL count of the host map 32 is increased by one. In contrast, if the path of the input URL is the same as that of the URL of the existing URL hash map, the policy information of the existing host map 32 is updated.

FIG. 5 is a diagram illustrating an example of URL hash map registration according to an embodiment of the present invention.

The URL hash map is a data structure for efficiently managing URLs and searching for them at high speed. The URL hash map may include a hash value, a buffer address, and a node.

The hash value is generated using host and path information of the URL. A unique hash value may be calculated using a hash algorithm such as CRC32.

The buffer address is the address of a buffer for storing the URL according to the hash value, and is configured as a linked list or array in preparation for cases where multiple URLs have the same hash value.

The node is a structure or object that contains URL information stored in each buffer. Typically, the node includes a URL, policy information, and additional metadata (e.g. registration time, path depth, etc.).

The URL hash map function includes registration, search, update, and delete functions.

The registration function adds a new URL to the URL hash map. In this case, the host and path information of the URL is parsed to generate a hash value, and a node is added to the buffer of the corresponding hash value.

The search function searches the URL hash map for a search target URL. A hash value is calculated using the host and path information and the URL is compared in the corresponding buffer to attempt matching.

The update function is a function of modifying the policy or metadata of an existing URL. The node of the corresponding URL may be found through the hash value and modified.

The delete function removes a specific URL from the URL hash map. The buffer corresponding to the hash value may be found and the node may be deleted.

FIG. 5 relates to the registration function of the URL hash map.

Referring to FIGS. 1 and 5, the apparatus 1 for matching URLs registers a host map for the input URL and then registers a URL hash map.

To this end, the apparatus 1 for matching URLs generates a hash value by combining the host and path information of the input URL. At this time, a hash value may be generated using the CRC32 algorithm.

The apparatus 1 for matching URLs may search for a URL hash map corresponding to a URL path step and register the URL in the found URL hash map.

The apparatus 1 may use part of the bits of the URL hash value (e.g., 16 bits of 32 bits) to search for a directory in the URL hash map.

The apparatus 1 stores URL information in the found directory, and by using a pre-generated buffer pool, may eliminate the load of new memory allocation.

As an example of URL hash map registration by URL path step, as shown in (a) of FIG. 5, an input URL \textcircled{1} (www.daum.net/travel/house/) corresponds to URL path step 2, so the URL is registered in a step-2 URL hash map. At this time, the apparatus 1 for matching URLs stores URL information in the found directory using a pre-generated buffer pool.

As another example, as shown in (b) of FIG. 5, an input URL \textcircled{2} (www.naver.com/video/) corresponds to URL path step 1, so the URL is registered in a step-1 URL hash map. At this time, the apparatus 1 for matching URLs uses a pre-generated buffer pool to store URL information in the found directory.

The table size of the URL hash map may be adjusted according to memory usage.

When the URL hash map is initially created, the apparatus 1 for matching URLs may pre-generate URL hash map space to save time during the URL input process.

Major variables when generating a URL hash map buffer are as follows:
uint32_t prefix_max: maximum matching step path size
uint32_t bucket_hashsize: maximum path host table size
uint32_t_size64: number of URL hash map buffers (hash map space) up to 64 bytes in size
uint32_t_size256: number of URL hash map buffers (hash map space) up to 256 bytes in size
uint32_t_size1024: number of URL hash map buffers (hash map space) up to 1024 bytes in size

The apparatus 1 for matching URLs may prevent memory waste by pre-allocating the size of the URL hash map buffer according to the length of the input URL.

When a host or URL is deleted, the URL hash map buffer may return to the buffer pool for management.

The apparatus 1 for matching URLs may allocate twice the number of URL hash map buffers to the host map. In this case, duplication between the host map and URL hash map is not allowed.

FIG. 6 is a diagram illustrating a flow of a method of matching URLs according to an embodiment of the present invention.

Referring to FIGS. 1 and 6, the apparatus 1 for matching URLs receives input of a search target URL (S610).

Next, the apparatus 1 searches the registered host map and URL path map for a matching URL (S620).

In the URL search step (S620), the apparatus 1 for matching URLs may search the registered host map for a matching host and may check whether a match is found (S630).

At this time, if no match is found in the host map, the apparatus 1 processes the result as “not match” (S640).

In contrast, when a match is found in the host map, the apparatus 1 for matching URLs checks the path URL count value of the host map.

If the path URL count value of the host map is 0, this means that no URL hash map exists. Accordingly, there is no need to search the URL hash map, and thus the apparatus 1 for matching URLs transfers the policy of the host map.

In contrast, if the path URL count value of the host map is greater than 0 (for example, 1), the apparatus 1 searches the URL hash map to check whether path matching is successful (S650).

In the URL hash map matching step (S650), the apparatus 1 attempts matching in the URL hash map by giving priority to the longest path based on path length. To this end, the apparatus 1 for matching URLs calculates a hash value using the URL having the longest path, and attempts path matching using the calculated hash value of the longest path. For example, when the longest path of the URL corresponds to URL path step 3, the apparatus 1 searches a step-3 URL hash map using the hash value of path step 3 to attempt path matching. If matching is successful, the policy of the step-3 URL hash map is transferred.

When matching fails, the apparatus 1 attempts path matching for the preceding path step. For example, the apparatus 1 calculates a hash value of path step 2, and search a step-2 URL hash map with the calculated hash value to attempt path matching. If matching is successful, the policy of the step-2 URL hash map is transferred.

When matching fails, the apparatus 1 attempts path matching for the preceding path step. For example, the apparatus 1 calculates a hash value of path step 1, and searches a step-1 URL hash map with the calculated hash value to attempt path matching. If matching is successful, the policy of the step-1 URL hash map is transferred.

That is, the method described above performs searching repeatedly while reducing the URL path steps one by one.

If matching is successful at a certain URL path step, the apparatus 1 for matching URLs transfers the policy of a URL hash map corresponding to the matched URL path step.

In contrast, when matching ultimately fails in the URL hash map, the policy of the host map is transferred.

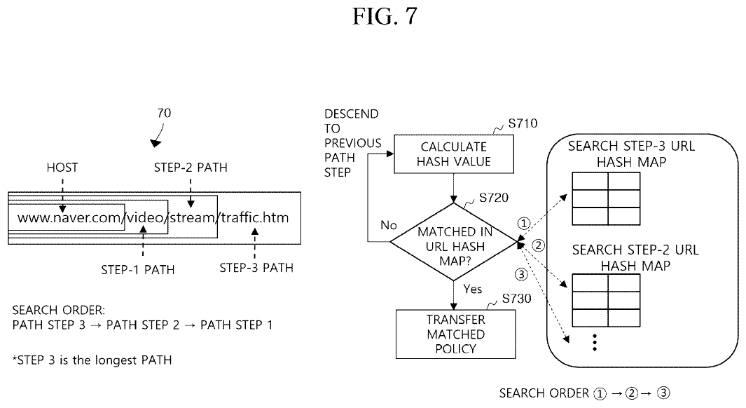

FIG. 7 is a diagram illustrating a URL search process according to a URL path step of a search target URL according to an embodiment of the present invention.

Referring to FIGS. 1 and 7, when the URL path step of the longest path of a search target URL 70 is at path step 3, the apparatus 1 for matching URLs calculates a hash value of path step 3 (S710), and then searches a step-3 URL hash map with the calculated hash value of path step 3 to attempt path matching (S720). If matching is successful, a policy of the step-3 URL hash map is transferred (S730).

In contrast, when matching of the longest path fails, the apparatus 1 repeatedly performs hash value calculation (S710) and URL hash map matching (S720) while descending to previous URL path steps (from path step 3→path step 2→path step 1) until matching succeeds. At this time, when matching is successful at a certain URL path step, the policy of the URL hash map corresponding to the matched URL path step is transferred (S730).

When path matching ultimately fails in the URL hash map, the policy of the host map is transferred.

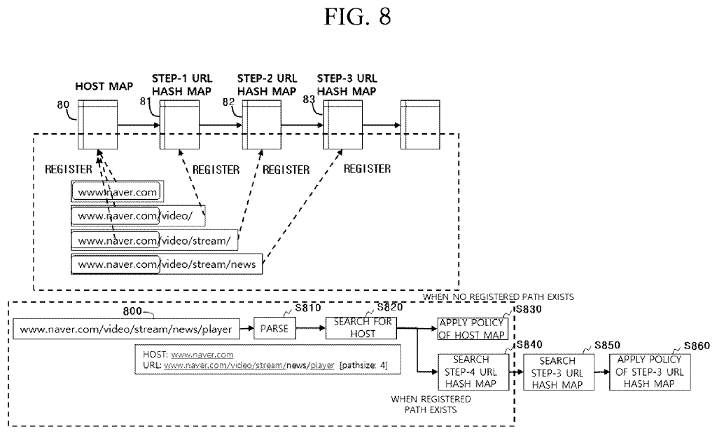

FIG. 8 is a diagram illustrating an example of a URL search process for a search target URL according to an embodiment of the present invention.

Referring to FIGS. 1 and 8, the apparatus 1 for matching URLs registers a host map and a URL hash map according to an input URL.

For example, when the input URL is www.naver.com, the apparatus 1 registers URL host information in a host map 80.

When the input URL is www.naver.com/video/, the apparatus 1 for matching URLs registers URL path information in a step-1 URL hash map 81.

When the input URL is www.naver.com/video/stream/, the apparatus 1 registers URL path information in a step-2 URL hash map 82.

When the input URL is www.naver.com/video/stream/news, the apparatus 1 registers URL path information in a step-3 URL hash map 83.

When a search target URL is input, the apparatus 1 for matching URLs searches the registered host map and URL hash map for the URL, matches the URL, and then applies a policy according to the matching result.

For example, when the search target URL is www.naver.com/video/stream/news/player 800, the apparatus 1 parses the search target URL (S810), confirms that the URL path step corresponds to path step 4 (pathsize: 4), and searches the registered host map for the host to perform matching (S820). At this time, if no path is registered, the policy of the host map is applied (S830).

In contrast, if a registered path exists, the apparatus 1 for matching URLs searches for the path in a URL hash map corresponding to the longest path step (e.g., path step 4) and attempts path matching (S840).

When matching of the longest path fails, the apparatus 1 attempts path matching by descending URL path steps until matching succeeds. At this time, when a path is found (S850) in a URL hash map 83 corresponding to a certain URL path step (e.g., path step 3) and path matching is successful, the policy of the URL hash map of the matched URL path step (e.g., step-3 URL hash map) is transferred (S860).

According to the present invention, it is possible to search for a URL at high speed using a URL map. By prioritizing matching of the URL having the longest path, processing load for long string searches may be reduced and matching speed may be increased.

Heretofore, the present invention has been described by focusing on the exemplary embodiments. It can be understood by those skilled in the art to which the present invention pertains that the present invention can be implemented in modified forms without departing from the essential feature of the present invention. Therefore, the disclosed embodiments should be considered as illustrative rather than determinative. The scope of the present invention is defined by the appended claims rather than by the foregoing description, and all differences within the scope of equivalents thereof should be constructed as being included in the present invention.

What is claimed is:

1. A method of matching Uniform Resource Locators (URLs) using an apparatus for matching URLs, the method comprising:
parsing an input URL to separate host information and path information, and calculating path depth;
registering a host map for the host information of the input URL;
when the input URL includes the path information, registering a URL hash map for a corresponding path;
when a search target URL is input, matching a host in the registered host map and, when a match is found, attempting path matching in a URL hash map for the corresponding path by giving priority to a longest path based on path length; and
applying a policy (e.g., action) according to the matching result.

2. The method of claim 1, wherein the registering of a host map comprises determining a registration method of the host map according to whether the input URL includes only host information or includes both host information and path information, and whether the host of the input URL is the same as an existing host.

3. The method of claim 1, wherein the registering of a host map comprises managing path URL count information of the host to prevent duplicate URL registration.

4. The method of claim 1, wherein the registering of a URL hash map comprises searching for a URL hash map corresponding to a URL path step (or depth) and registering the URL in the found URL hash map.

5. The method of claim 1, wherein the registering of a URL hash map comprises pre-allocating a size of a URL hash map buffer according to a length of the input URL to prevent memory waste.

6. The method of claim 1, wherein the matching by giving priority to the longest path comprises:
checking a path URL count value of the host map when the host is matched in the host map;
transferring a policy of the host map when the path URL count value of the host map is 0; and
searching the URL hash map to check whether path matching is successful when the path URL count value of the host map is greater than 0.

7. The method of claim 1, wherein the matching by giving priority to the longest path comprises, when the attempt to match the longest path fails during a URL matching process, attempting path matching while descending step by step to shorter paths.

8. The method of claim 1, wherein the matching by giving priority to the longest path comprises:
attempting path matching at a URL path step of the longest path using a hash value of the URL having the longest path, and when matching is successful, transferring a policy of a URL hash map corresponding to the longest path;
when matching of the longest path fails, repeatedly attempting path matching by descending to previous URL path steps until matching is successful;
when matching is successful at a certain URL path step, transferring a policy of a URL hash map corresponding to the matched URL path step; and
transferring a policy of the host map when path matching ultimately fails in the URL hash map.

9. An apparatus for matching Uniform Resource Locators (URLs), comprising:
a URL parsing unit configured to parse an input URL to separate host information and path information, and calculate path depth;
a host map registration unit configured to register a host map for the host information of the input URL;
a URL hash map registration unit configured to, when the input URL includes the path information, register a URL hash map for a corresponding path;
a URL matching unit configured to, when a search target URL is input, match a host in the registered host map, and, when matched, attempt path matching in the URL hash map of the corresponding path by giving priority to the longest path based on path length; and
a policy implementation unit configured to apply a policy according to the matching result.

10. The apparatus of claim 9, wherein the URL matching unit is configured to:
check a path URL count value of the host map when the host is matched in the host map,
transfer a policy of the host map when the path URL count value of the host map is 0, and
search the URL hash map to check whether path matching is successful when the path URL count value of the host map is greater than 0.

11. The apparatus of claim 9, wherein the URL matching unit is configured to, when the attempt to match the longest path fails during a URL matching process, attempt path matching while descending step by step to shorter paths.

12. The apparatus of claim 9, wherein the URL matching unit is configured to:
attempt path matching at a URL path step of the longest path using a hash value of the URL having the longest path, and when matching is successful, transfer a policy of the URL hash map corresponding to the longest path,
when matching of the longest path fails, repeatedly attempt path matching by descending to previous URL path steps until matching is successful, and when matching is successful at a certain URL path step, transfer a policy of a URL hash map corresponding to the matched URL path step, and
transfer the policy of the host map when the path matching ultimately fails in the URL hash map.
